(19) United States
(12) Patent Application Publication
(10) Pub. No.: US 2014/0009858 A1
(43) Pub. Date: Jan. 9, 2014

(54) SURGE ARRESTER WITH REPLACEABLE OVERVOLTAGE PROTECTION MOD

(71) Applicant: Jaromir Suchy, Labem-Skorotice (CZ)

(72) Inventor: Jaromir Suchy, Labem-Skorotice (CZ)

(21) Appl. No.: 14/005,848

(22) PCT Filed: Feb. 27, 2012
(86) PCT No.: PCT/CZ12/00017

§ 371 Date: Sep. 18, 2013

(30) Foreign Application Priority Data
Apr. 1, 2011 (CZ) PV2011-183

(51) Int. Cl. H02H 3/20

(52) U.S. Cl. CPC H02H 3/20
USPC 361/91.1

(57) ABSTRACT

The surge arrester with a replaceable overvoltage protection module in a single-pole or a multi-pole configuration, consisting of the U-shaped overvoltage protection base (5) adjusted for inserting one or three or four overvoltage protection replaceable modules (2), where the overvoltage protection replaceable module (2), featuring a visual status signaling window (17) of the thermal disconnector implemented via a visual signaling flexible strip (18), comprises C-shaped plug contacts (1) on the opposite lateral sides and a coding field (4) on one or both lateral sides, comprising of rectangular projections and/or indentations of a different profile, width and length, which slide in the complementary indentations and/or projections on one or both internal lateral sides of the overvoltage protection base (5). The overvoltage protection replaceable module (2) also comprises at least two guide pins (3) in its bottom part, whereas in the opposite positions the overvoltage protection base (5) comprises guide holes (6) and in the positions opposite to the plug contacts (1) the overvoltage protection base (5) comprises U-shaped contact sockets (7), and, at the same time, the overvoltage protection replaceable module (2) comprises a thermal disconnector located on the fixing case (11) of the overvoltage protection replaceable module (2) housing.

### TECHNICAL FIELD

The invention refers to a surge arrester with a replaceable overvoltage protection module either in a single-pole or a multi-pole configuration, to be connected to the protected distribution system, which comprises an overvoltage protection base, into which one or more replaceable overvoltage protection modules are plugged in and which also comprise plug contacts, a coding field and thermal disconnector for one or more protection elements, which disconnects protection elements of the surge arrester from the protected distribution system if overvoltage occurs.

### BACKGROUND OF THE INVENTION

Modern surge arrester constructions are designed to facilitate easy replacement of the surge arrester if the protection element is damaged without having to disconnect the supply conductors, through which the surge arresters are connected to the distribution system. Known solutions use protection elements located in a replaceable overvoltage protection module comprising plug contacts for connection with the overvoltage protection base. The overvoltage protection base, usually U-shaped in a single-pole or multi-pole configuration, is adjusted to allow one or more replaceable overvoltage protection modules to be inserted into it and contains contact sockets, terminal clamps and screws to connect the conductors of the distribution system. The plug contacts of the replaceable module and those of the contact sockets shall be capable of carry high pulse and short-circuit currents without any damage being caused. The design of the construction is very difficult to resolve, due to extreme stress on this contact system caused by electromagnetic forces and generated heat. The design of the surge arresters with a replaceable overvoltage protection module must prevent plugging the replaceable overvoltage protection module with protection elements into the incorrect supply voltage.

An example of such a surge arrester arrangement is shown in document EP 1587188 “Überspannungsschutzgerät”. This is a surge arrester for the protection of electrical low-voltage systems, which consists of an overvoltage protection base with terminal clamps for phase conductors and earth resp. neutral conductors and at least one replaceable overvoltage protection module with at least one protection element embedded in the case housing, with the overvoltage protection base having at least one remote signal contact with a switch signaling the status of at least one replaceable overvoltage protection module. The overvoltage protection base comprises V-shape contact sockets connected with the terminal clamps and the replaceable overvoltage protection module features matching flat plug contacts, so consequently, the replaceable overvoltage protection module can be inserted to the overvoltage protection base, whereas the replaceable overvoltage protection module comprises an optical status indicator. The optical status indicator and the remote signal contact switch can be controlled using a common mechanical control system. The solution described in this document prevents the insertion of an incorrect replaceable overvoltage protection module using a coding element in the overvoltage protection base and a complementary anti-coding element in the replaceable overvoltage protection module. The disadvantage of this solution is that it has a restricted number of coding options and there is a potential of damage using a bigger force.

The known solution under CZ/EP 1900072 “A plug-in surge arrester with one or more overvoltage protection elements” describes a surge arrester design with one or more plug-in overvoltage protection elements, whereas the contact of the plug-in element with the base is solved using a U-shape contact mate part, which consists of shaped flexible elements to generate pressure onto the plug contacting surfaces. This solution does not work without this component.

Document U.S. Pat. No. 7,806,716 “Plug-In Combination of Appliances for Protecting Against Overvoltages” describes a solution using a “tear”-shaped coding pin on a replaceable module and a coding hole with a complementary shape in the base. The axis of the coding pin and the coding hole must be matching, otherwise the replaceable module will not plug into the base. By turning the position of the coding pin and the coding hole, usually by 60 degrees, it is possible to program various options for different types of protection elements or voltage. Due to restricted space the coding pin has a small cross section, hence its low robustness, as a result of which it breaks off easily and the incorrect type of replaceable module can be plugged into the base. The number of coding options is also restricted to six here.

Designs of thermal disconnectors used in practice frequently use tin solder as a thermally sensitive sensor with suitable additives regulating the softening temperature. The individual parts of the thermal disconnector, the specific design of which depends on the size of the pulse current maximum amplitude of the surge arrester, are usually connected using temperature adequate tin solder. A spring action is used to disconnect or separate these.

The solution known from document DE 10 2006 038 005 “Anschluss—and Basisteil zur Aufnahme eines steckbaren Überspannungsableiters” uses a suitably-shaped copper strip as one part of the thermal disconnector of the protection element, usually a varistor. The copper strip is fixed to a flat contact of the protection element via a spot weld on one side providing electrical conductivity at the same time, and on its opposite side, using soldering of suitable temperature solder, it is connected to the projection of a metallic electrode which, at the same time, is soldered to the protection element. A compressive spring acts on the shaped copper strip using a lever pivotable about the axis. If a defect of the protection element occurs, the protection element heats up, the parts of the thermal disconnector heat up simultaneously, the solder becomes soft, resulting in the loss of rigidity of the soldered connection. By the action of the spring and the pivotable lever, the shaped copper strip starts moving in a circular trajectory, which is defined by its length and free space in the housing, the free end separates from the projection of the metallic electrode, resulting in disconnecting from the distribution system. The pivotable lever is also used to signal the defect of the protection elements visually and their disconnecting from the distribution system, i.e. the loss of functionality of the surge arrester. The disadvantage of this solution is that the spatial arrangement makes it impossible to separate both parts of the thermal disconnector sufficiently, thus limiting the application of this solution to higher operating voltages. In some circumstances the disconnect speed is not sufficient and an arch can develop on the thermal disconnector during the disconnection.

### SUMMARY OF THE INVENTION

The said deficiencies are considerably eliminated using a surge arrester with a replaceable overvoltage protection module in a single-pole or a multi-pole configuration, comprising an overvoltage protection base and a replaceable overvoltage protection module, subject to this invention, characterized in that a U-shaped overvoltage protection base is adjusted for inserting one, three or four replaceable overvoltage protection modules, where the replaceable overvoltage protection module, comprising a visual status signaling window of the thermal disconnector via a flexible visual signaling strip, features C-shaped plug contacts on the opposite lateral sides, and on one or both lateral sides it features a coding field consisting of rectangular projections and/or indentations of a different profile, width and length, which slide in the complementary indentations and/or projections on one or both internal lateral sides of the overvoltage protection base; the replaceable overvoltage protection module also comprises at least two guide pins at the bottom part of the overvoltage protection base, guide holes situated opposite these in the overvoltage protection base, U-shape contact sockets located opposite the plug contacts in the overvoltage protection base, and, at the same time, the replaceable overvoltage protection module features a thermal disconnector situated on the fixing case of the replaceable overvoltage protection module housing comprising a connecting part of the plug contact, a slider, with at least one thrust element on its rear face, and on its front side it leans against the sliding interconnection of the thermal disconnector, where the sliding interconnection is fixed to the cantering pin of the slider, and the sliding interconnection of the thermal disconnector is situated between the connecting part of the plug contact and the projection of the connecting element of the thermal disconnector, and at the same time, at least one protection element featuring a connecting element of the protection element from the opposite side links to the connecting element of the thermal disconnector, or if two or more protection elements are used in an advantageous flat arrangement one above other and situated between the connecting element of the thermal disconnector and the connecting element of the protection elements, and the opposite lateral sides of these protection elements are provided with a pair of electrically conductive interconnections.

The coding field on the replaceable overvoltage protection module, consisting of a group of projections and/or rectangular indentations of a different profile, width and length, which slide in the complementary indentations and/or projections on the overvoltage protection base, increases the number of applicable coding field options, as a result of which a larger number of replaceable overvoltage protection module types are covered. Additionally, even if huge force were applied, an incorrect replaceable overvoltage protection module cannot be inserted in the overvoltage protection base, which is particularly important for prevention of inserting the replaceable overvoltage protection module with protection elements in lower voltage than the voltage in the distribution system, which in extreme circumstances could cause seasoning, fire or an explosion with devastating effects on the surge arrester and its environment, or injury to the operator handling the replaceable overvoltage protection module.

The advantageous configuration of the surge arrester with a replaceable overvoltage protection module is characterized in that the projections and indentations of the coding field have a rectangular and/or square shape and/or circular segment.

This arrangement allows for the extension of the number of applicable coding field options.

The implementation of a surge arrester with a replaceable overvoltage protection module brings an advantage of the guide pins and the guide holes having a circular cross section.

The cross section of the guide pins and guide holes can be square, rectangular or triangular, for example, however, the is circular cross section is the most advantageous, taking into account manufacturing and handling the replaceable overvoltage protection module while being inserted in the overvoltage protection base. The guide pins situated on the bottom side of the replaceable overvoltage protection module are cylindrical and slide in the guide holes in the overvoltage protection base in such a manner that once they have been inserted, they guide the replaceable overvoltage protection module into the exact position against the overvoltage protection base.

Another advantage of the surge arrester with a replaceable overvoltage protection module is that the thrust element consists of a pre-pressed compressive spring.

This design ensures the correct functioning of the thermal disconnector.

For the correct functioning of the surge arrester with a replaceable overvoltage protection module it is an advantage that the contact socket features at least one connecting clamp with at least one screw.

The terminal clamps with screws facilitate the connection of the supply conductors of the distribution system to the overvoltage protection base containing contact sockets. Another advantage of the surge arrester with a replaceable overvoltage protection module is that the plug contact features a connecting part of the plug contact, situated on the side wall of the upper half of the plug contact case housing and it is connected with it via an oblique segment so that the surfaces of the plug contact and the connecting part of the plug contact lie in different parallel planes.

This design arrangement facilitates contact connection of the plug contact with the sliding interconnection of the thermal disconnector.

For the correct functioning of the surge arrester with a replaceable overvoltage protection module it is also advantageous that the plug contact features a contacting part of the plug contact with at least one cog on the bottom side of the lower half of the plug contact case housing and two symmetrically situated thrust elements of the plug contact on the top face, of which each thrust element features at least one cog and the contacting part of the plug contact forms an angle from 0 to 10 degrees with the thrust element of the plug contact.

In this invention the contact socket does not need to comprise an inserted shaped flexible element to exert pressure on the plug contact as used in the known solutions. Due to the acting of electromagnetic force at the current pulse flowing, the contacting part of the plug contact with the thrust element of the plug contact repel each other, resp. they push each other away, by which they exert dynamic pressure on the contact socket. The higher the pulse current, the greater the thrust force, which is one of the advantages of this invention.

### BRIEF DESCRIPTION OF THE DRAWINGS

The invention will be explained in detail using the drawings, in which

FIG. 1 shows the plug contact in its basic arrangement on the left and in the unfolded status on the right.

FIG. 2 shows a replaceable overvoltage protection module with two plug contacts, four guide pins and a coding field with three projections.

FIG. 3 shows the overvoltage protection base in a single-pole configuration with two contact sockets and four guide holes.

FIG. 4 shows the replaceable overvoltage protection module in its slide out position against the contact sockets on the left, in the plugged-in position on the right, where each contact socket is provided with two terminal clamps and two screws.

FIG. 5 shows the set of the thermal disconnector with the fixing case of the replaceable overvoltage protection module housing, a slider, sliding interconnection of the thermal disconnector, cantering pin, connecting part of the plug contact and the projection of the thermal disconnector connecting element.

FIG. 6 shows the interior of the thermal disconnector with two thrust elements, sliding interconnection of the thermal disconnector, connecting part of the plug contact and the projection of the thermal disconnector connecting element.

FIG. 7 shows a detailed side view of the thermal disconnector with the connecting part of the plug contact, sliding interconnection of the thermal disconnector, connecting element of the thermal disconnector comprising the projection, and five protection elements and two electrically conductive interconnections.

FIG. 8 shows a detailed side view of the connecting part of the protection elements to connect the plug contact with the connecting element of the protection elements featuring two electrically conductive interconnections.

FIG. 9 shows the replaceable overvoltage protection module with the visual status signaling window of the thermal disconnector.

FIG. 10 shows the internal arrangement of the replaceable overvoltage protection module with the flexible strip of the visual status signaling of the thermal disconnector and the slider of the thermal disconnector.

FIG. 11 shows the surge arrester in a single-pole configuration consisting of the overvoltage protection base and one inserted replaceable overvoltage protection module.

FIG. 12 shows the surge arrester in a single-pole configuration consisting of the overvoltage protection base with one slid out replaceable overvoltage protection module.

FIG. 13 shows the surge arrester in a three-pole configuration consisting of the overvoltage protection base with three inserted replaceable overvoltage protection modules.

FIG. 14 shows the surge arrester in a three-pole configuration consisting of the overvoltage protection base with three slid out replaceable overvoltage protection modules.

FIG. 15 shows the surge arrester in a four-pole arrangement consisting of the overvoltage protection base with four inserted replaceable overvoltage protection modules.

FIG. 16 shows the surge arrester in a four-pole arrangement consisting of the overvoltage protection base with four slid out replaceable overvoltage protection modules.

FIG. 17 shows the view from above of the advantageous plug contact configuration comprising the plug contact connecting part, plug contact contacting part, two thrust elements of the plug contact and four cogs.

FIG. 18 shows the bottom view of the advantageous plug contact configuration comprising the plug contact connecting part, plug contact contacting part, two plug contact thrust elements and four cogs.

### EXAMPLES OF THE INVENTION

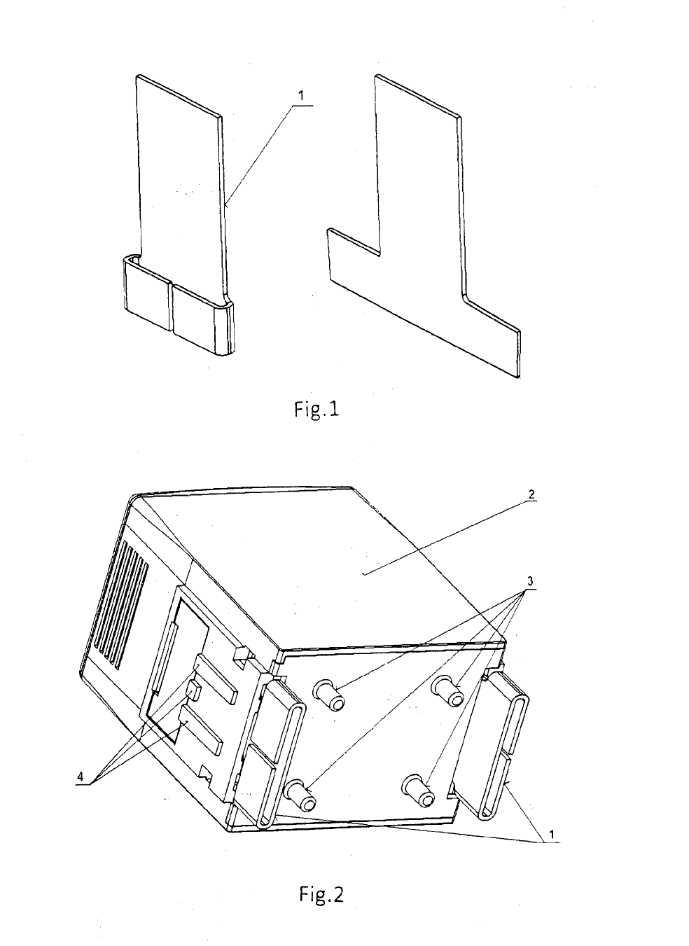

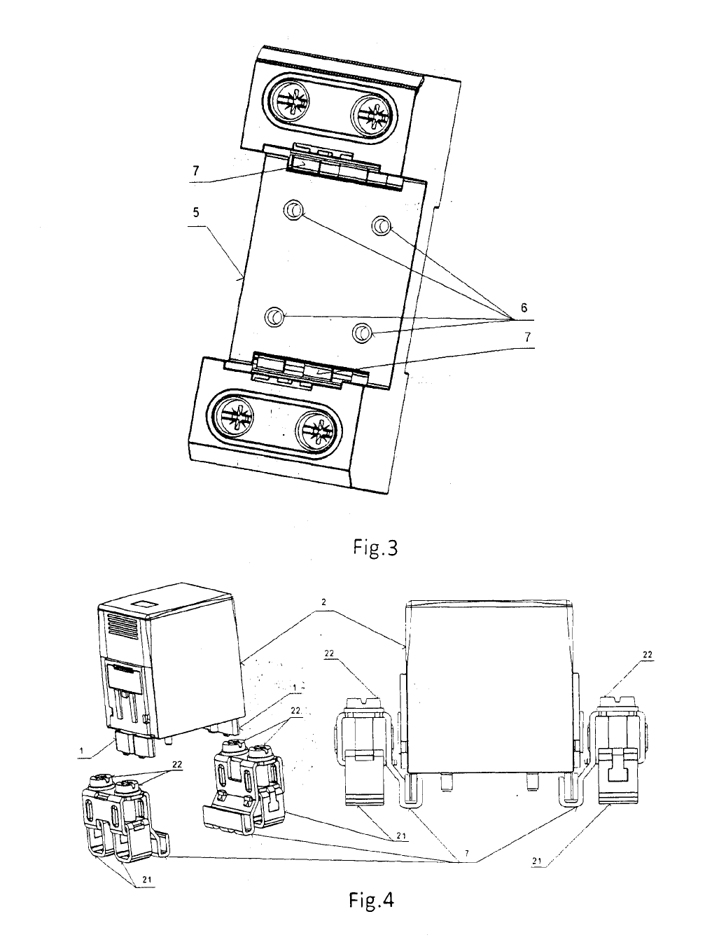

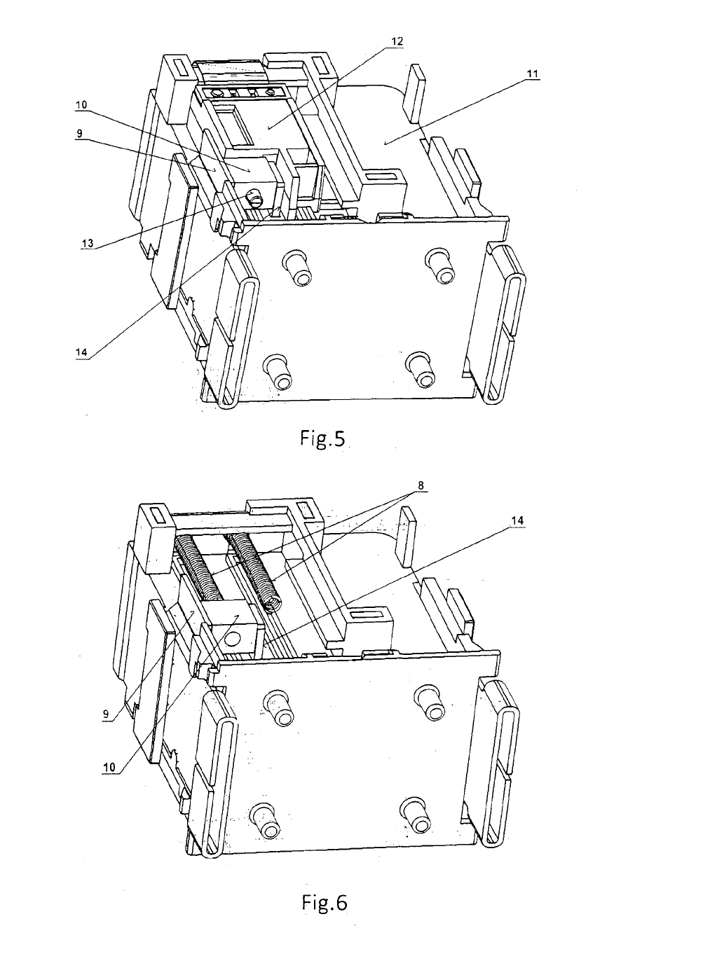

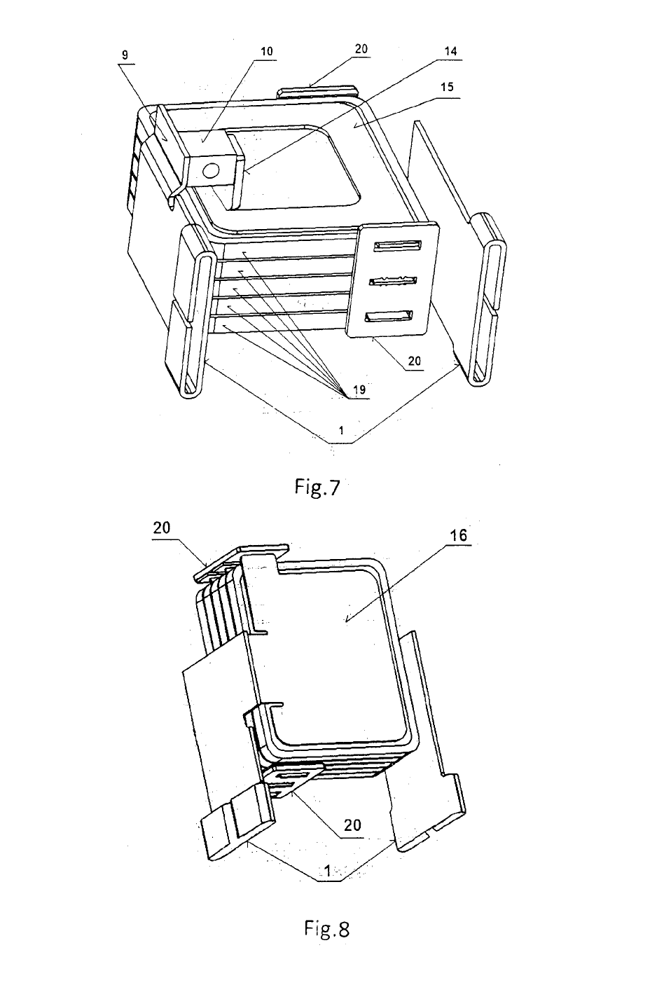

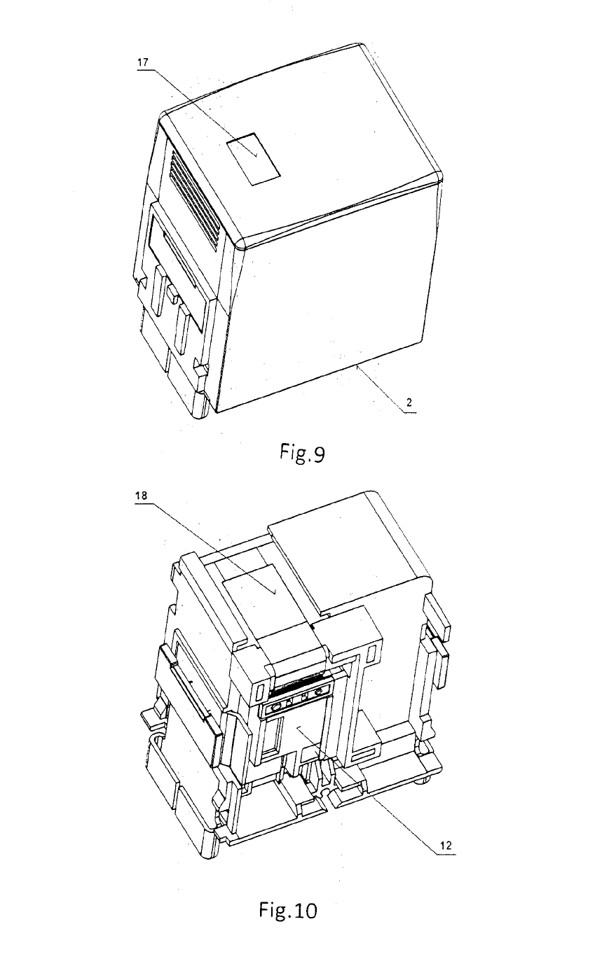

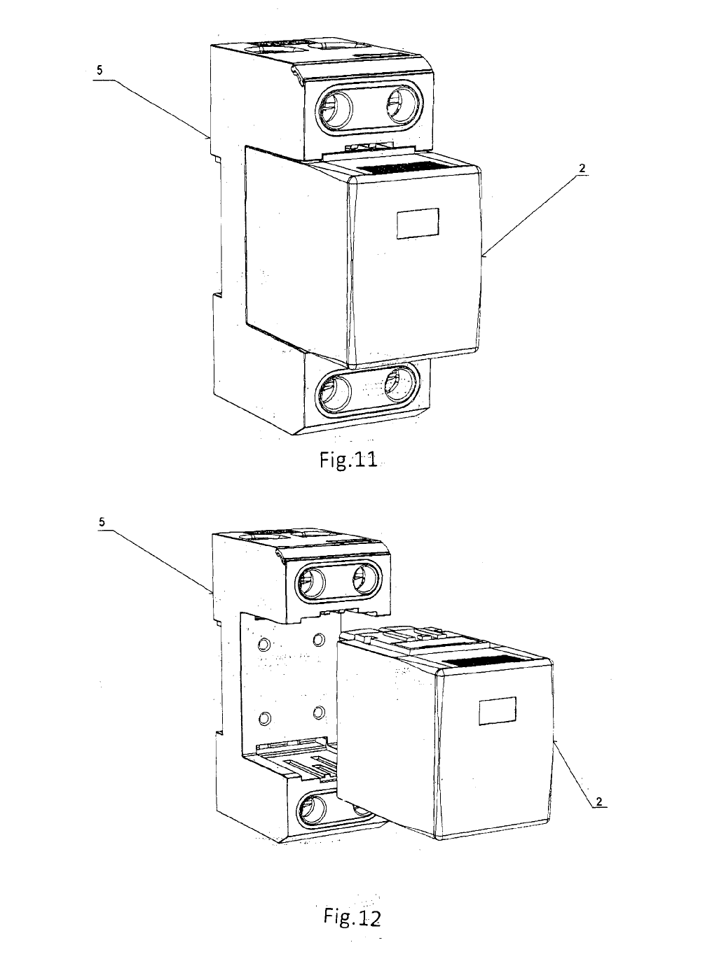

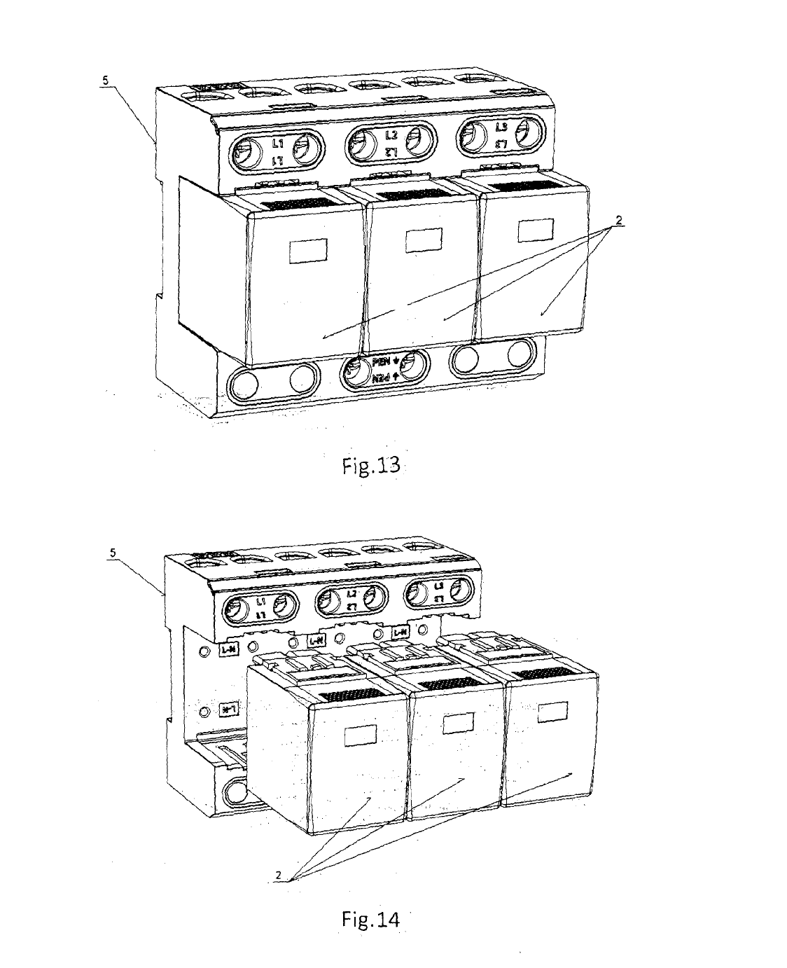

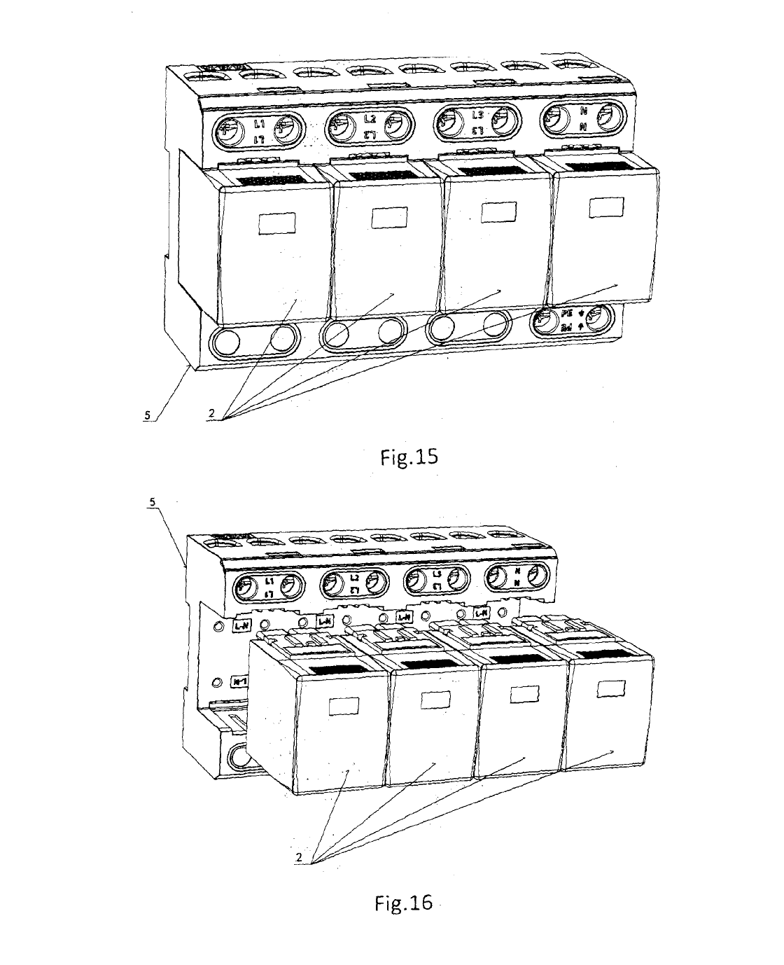

The surge arrester with a replaceable overvoltage protection module in a single-pole or a multi-pole configuration shown in FIG. 3 consists of an overvoltage protection base 5 and as shown in FIG. 2 of an overvoltage protection replaceable module 2. The U-shaped overvoltage protection base 5 is designed as shown in FIGS. 11 and 12 for inserting one, or as shown in FIGS. 13 and 14 three, or as shown in FIGS. 15 and 16 four overvoltage protection replaceable modules 2 in it. As shown in FIG. 9, the overvoltage protection replaceable module 2 features a visual status signaling window 17 of the thermal disconnector implemented according to FIG. 10 via a visual signaling flexible strip 18. The overvoltage protection replaceable module 2 according to FIG. 2 features C-shaped plug contacts 1 on the opposite lateral sides as shown in FIG. 1 and a coding field 4, on both lateral sides, comprising rectangular projections and/or indentations of a different profile, width and length, which slide in the complementary indentations and/or projections on both internal lateral sides of the overvoltage protection base 5 according to FIG. 3. The overvoltage protection replaceable module 2 according to the illustration in FIG. 2 features four guide pins 3 on the bottom part, and the overvoltage protection base 5 according to the illustration in FIG. 3 features guide holes 6 opposite these, and opposite the plug contacts 1 in the overvoltage protection base 5 there are U-shaped contact sockets 7 as shown in FIG. 4. The overvoltage protection replaceable module 2 subject to FIGS. 5 and 6 comprises a thermal disconnector located on the fixing case 11 of the overvoltage protection replaceable module 2 housing consisting of the connecting part 9 of the plug contact 1, a slider 12, featuring two thrust elements 8 on its rear face, and on its front side leaning against the sliding interconnection 10 of the thermal disconnector, fixed to the cantering pin 13 of the slider 12, where the sliding interconnection 10 of the thermal disconnector is situated as shown in FIG. 7 between the connecting part 9 of the plug contact 1 and the projection 14 of the connecting part 15 of the thermal disconnector. Where according to FIG. 7 to the connecting element 15 of the thermal disconnector link five protection elements 19 in flat configuration arranged one above other between the connecting element 15 of the thermal disconnector and the connecting element 16 of the protection elements 19 according to FIG. 8. The opposite lateral sides of these protection elements 19 comprise two electrically conductive interconnections 20. If only one protection element 19, comprising a connecting element 16 of the protection element 19 from the opposite side, links to the connecting element 15 of the thermal disconnector, the electrically conductive interconnections 20 are not used.

The thermal-disconnector disconnects one or more protection elements 19, usually varistors, from the protected distribution system, should these be overloaded or damaged. The connecting part 9 of the plug contact 1, the sliding interconnection 10 of the thermal disconnector and the projection 14 of the connecting part 15 of the thermal disconnector are fixed together using tin solder with a low softening point, and an is electrically conductive soldered connection. The sliding interconnection 10 of the thermal disconnector is located in its basic position as shown in FIGS. 5, 6 and 7. If overvoltage occurs, the protection element 19 starts heating up and consequently, other parts of the thermal disconnector heat up, too, once the temperature of the solder softening is exceeded, the joint becomes loose and the slider 12 and the sliding interconnection 10 of the thermal disconnector move to the second extreme position due to the action of the thrust element 8, resulting in disconnecting the electrical conductive connection between the connecting part 9 of the plug contact 1 and the projection 14 of the thermal disconnector connecting part 15. By this the protection element 19 disconnects from the protected distribution system.

The slider 12 according to FIG. 5 comprises a cantering pin 13 to guide the sliding interconnection 10 of the thermal disconnector and to facilitate the assembly. The slider 12 is mechanically connected via the visual signaling flexible strip 18, as shown in FIG. 10. By changing the position of the slider 12, the visual signaling flexible strip 18 also moves outside the visual signaling window 17 as shown in FIG. 9, as a result of which the color in the visual signaling window 17 changes, since the visual signaling flexible strip 18 has a different color than the fixing case 11 of the overvoltage protection replaceable module 2 housing, situated underneath.

In the advantageous configuration the projections and indentations of the coding field 4 have a rectangular and/or square profile and/or circular segment.

FIG. 2 shows the overvoltage protection replaceable module 2 with the coding field 4 featuring three rectangular projections; FIG. 3 shows the overvoltage protection base 5 featuring three complementary rectangular indentations. Consequently, only the overvoltage protection replaceable module 2 with the matching projections can be inserted in the overvoltage protection base 5. The information of the coding field 4 is defined by the width and length of the projection, its profile, number of projections in the coding field 4 and the gap width between the projections. On the overvoltage protection replaceable module 2 the coding field 4 can comprise a combination of projections and indentations, where the projection on the overvoltage protection replaceable module 2 complements the indentation in the overvoltage protection base 5 and conversely.

In the advantageous configuration the guide pins 3 and guide holes 6 have a circular cross section.

This arrangement is shown in FIG. 2, where on the bottom side of the overvoltage protection replaceable module 2 four cylindrical guide pins 3 are located symmetrically along the center, provided with a conical termination, allowing the pins to be inserted into the complementary guide holes 6 in the overvoltage protection base 5, where the holes extend conically, as shown in FIG. 3. This guides the overvoltage protection replaceable module 2 in inserting it into the exact position against the overvoltage protection base 5.

The thrust element 8 consists of a pre-pressed compressive spring in the advantageous model.

FIG. 6 shows two thrust elements 8 via pre-pressed compressive springs.

The advantageous model shown in FIG. 4 shows contact sockets 7 always with two terminal clamps 21 with two screws 22.

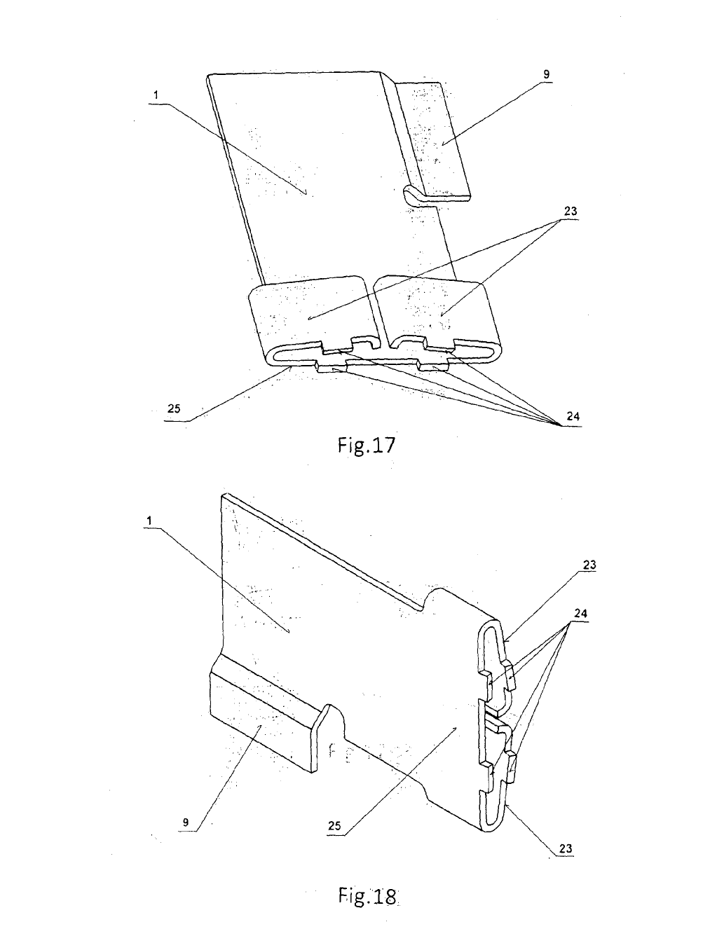

This arrangement offers the possibility of connecting one or two conductors of the protected distribution system to each contact socket 7 as required. In the advantageous model according to the illustrations in FIGS. 17 and 18 the plug contact 1 comprises a plug contact 1 connecting part 9, situated on the side of the top half of the plug contact 1 case and linked to it via an oblique segment so that the surfaces of the plug contact 1 and the plug contact 1 connecting part 9 lie in different parallel planes.

FIGS. 5, 6 and 7 show that such an arrangement deals with the contact connection of the plug contact 1 with the sliding interconnection 10 of the thermal disconnector.

In the advantageous model shown in FIGS. 17 and 18, on the bottom side of the lower half of the plug contact 1 case, the plug contact 1 comprises a contacting part 25 of the plug contact 1 with two cogs 24 located symmetrically and on the top face, two thrust elements 23 of the plug contact 1 located symmetrically, each with one cog 24, where the contacting part 25 of the plug contact 1 forms an angle from 0 to 10 degrees with the thrust element 23 of the plug contact 1.

The cogs 24 enable to the plug contact 1, comprising a flexible metallic strip to be guided into the contact socket 7.

### INDUSTRIAL UTILIZATION

The surge arrester with a replaceable overvoltage protection module in a single-pole or a multi-pole configuration subject to this invention is a product that can be used in any situation where overvoltage adversely affects the distribution system. The plug contacts of the replaceable overvoltage protection module and the contact sockets in the overvoltage protection base have been designed to be capable of carry high pulse and short-circuit currents without damage. The coding field on the replaceable overvoltage protection module and its counter element in the overvoltage protection base prevent plugging the replaceable overvoltage protection module with protection elements into an incorrect supply voltage. The thermal disconnector disconnects protection components from the protected distribution system if these are overloaded and damaged and consequently, reduces the risk of property loss and operator injuries.

1. The surge arrester with a replaceable overvoltage protection module in a single-pole or a multi-pole configuration, consisting of an overvoltage protection base (5) and an overvoltage protection replaceable module (2), is characterized in that the U-shaped overvoltage protection base (5) is adjusted for inserting one or three or four overvoltage protection replaceable modules (2), where the overvoltage protection replaceable module (2), featuring a visual status signaling window (17) of the thermal disconnector implemented via a visual signaling flexible strip (18), comprises C-shaped plug contacts (1) on the opposite lateral sides and a coding field (4), on one or both lateral sides, comprising rectangular projections and/or indentations of a different profile, width and length, which slide in the is complementary indentations and/or projections on one or both internal lateral sides of the overvoltage protection base (5), additionally, the overvoltage protection replaceable module (2) also comprises at least two guide pins (3) in its bottom part, whereas in the opposite positions the overvoltage protection base (5) comprises guide holes (6) and in the positions opposite to the plug contacts (1) the overvoltage protection base (5) comprises U-shaped contact sockets (7), and, at the same time, the overvoltage protection replaceable module (2) comprises a thermal disconnector located on the fixing case (11) of the overvoltage protection replaceable module (2) housing and consisting of the connecting part (9) of the plug contact (1), a slider (12), on the rear side featuring at least one thrust element (8), on its front side leaning against the sliding interconnection (10) of the thermal disconnector, fixed on the cantering pin (13) of the slider (12), where the sliding interconnection (10) of the thermal disconnector is situated between the connecting part (9) of the plug contact (1) and the projection (14) of the connecting part (15) of the thermal disconnector, where at the same time, at least one protection element (19) comprising a connecting element (16) of the protection element (19) from the opposite side links to the connecting element (15) of the thermal disconnector, or if two or more protection elements (19) are used, with the advantage in flat configuration arranged one above other between the connecting element (15) of the thermal disconnector and the connecting element (16) of the protection elements (19), the opposite lateral sides of these protection elements (19) comprise two electrically conductive interconnections (20).

2. The surge arrester with a replaceable overvoltage protection module as claimed in claim 1, is characterized in that the projections and indentations of the coding field (4) have a rectangular and/or square profile and/or circular segment.

3. The surge arrester with a replaceable overvoltage protection module as claimed in claims 1 and 2, is characterized in that the guide pins (3) and guide holes (6) have a circular cross section.

4. The surge arrester with a replaceable overvoltage protection module as claimed in claims, 1 2 and 3, is characterized in that the thrust element (8) comprises a pre-pressed compressive spring.

5. The surge arrester with a replaceable overvoltage protection module as claimed in claims 1 to 4, is characterized in that the contact socket (7) comprises at least one connecting clamp (21) with at least one screw (22).

6. The surge arrester with a replaceable overvoltage protection module as claimed in claims 1 to 5, is characterized in that the plug contact (1) comprises a connecting part (9) of the plug contact (1), situated on the side of the upper half of the plug contact (1) case and links to it via an oblique segment so that the surfaces of the plug contact (1) and the connecting part (9) of the plug contact (1) lie in different parallel planes.

7. The surge arrester with a replaceable overvoltage protection module as claimed in claims 1 to 6, is characterized in that the plug contact (1) comprises a contacting part (25) of the plug contact (1) with at least one cog (24) on the bottom side of the bottom half of the plug contact (1) case and on the top face, two thrust elements (23) of the plug contact (1) located symmetrically, of which each comprises at least one cog (24), where the contacting part (25) of the plug contact (1) forms an angle from 0 to 10 degrees with the thrust element (23) of the plug contact (1).
